(19) United States
(12) Patent Application Publication
(10) Pub. No.: US 2015/0134113 A1
(43) Pub. Date: May 14, 2015

(54) METHOD FOR OPERATING A ROBOT

(71) Applicant: DEUTSCHES ZENTRUM FÜR LUFT-UND RAUMFAHRT E.V., Köln (DE)

(72) Inventors: Rainer Konietschke, Worthsee (DE); Stefan Jörg, Munchen (DE); Julian Klodmann, Munchen (DE)

(73) Assignee: DEUTSCHES ZENTRUM FÜR LUFT-UND RAUMFAHRT E.V., Köln (DE)

(21) Appl. No.: 14/395,539

(22) PCT Filed: Apr. 16, 2013
(86) PCT No.: PCT/EP2013/057888

§ 371 Date: Oct. 20, 2014

(30) Foreign Application Priority Data
Apr. 18, 2012 (DE) 102012206350.1

(51) Int. Cl. B25J 9/16

(52) U.S. Cl. CPC B25J 9/1666
USPC 700/255

(57) ABSTRACT

The invention relates to a method for operating a robot, including detecting the spatial position and/or location of at least one delimiting structure which causes a kinematic delimitation of the work space that can be reached by an instrument connected to a robotic arm of the telemanipulation robot; and continuously representing the reachable work space on an object to be manipulated by the instrument in such a way that a change in the position and/or location of the delimiting structure results, in real time, in a change of the represented reachable work space.

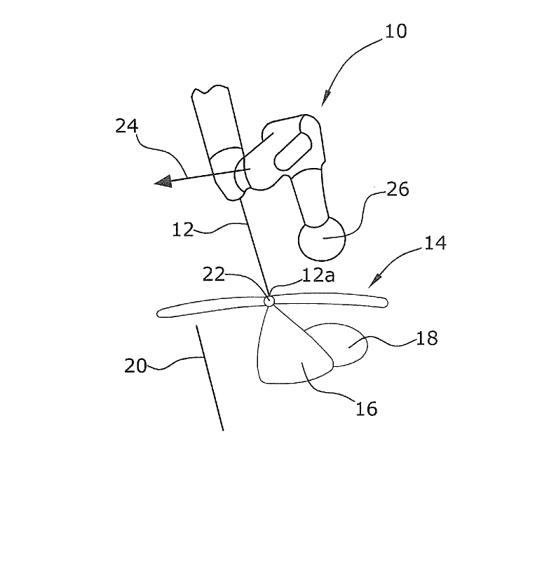

The invention relates to a method for operating a robot, in particular a telemanipulation robot.

A telemanipulation robot can be used, for example, to carry out surgery on a patient. Telemanipulation robots are additionally used in industry, for example to position objects or for welding. A telemanipulation robot is controlled by a user by way of an input device.

The telemanipulation robot carries out its task within a workcell. When setting up such a workcell, it must be ensured that the functional end of the robot reaches those points where it is supported to carry out its task. At the same time, it must be ensured that the robot does not harm or damage any other structures.

According to the prior art, a robotic workcell is configured either according to the trial and error method or with the aid of a planning environment (in the virtual reality in which the cell can be simulated). The transfer to the real workcell is then carried out by way of measurement or registration, so that the robot can be positioned in the planned spot.

The described method for configuring a robotic workcell is suitable for workcells that are set up one time and then remain unchanged. The method is less suitable for workcells that are to be set up flexibly for different tasks that are to be carried out. This is due to the fact that this method is very cumbersome and time-consuming. The method is not suitable in particular in applications in the medical field, where the workcell has to be newly laid out for each patient. The method is also not suitable for flexible workcells.

Moreover, planning is not always possible, for example due to missing information, such as about the patient's exact anatomy at the time of surgery.

It is the object of the invention to provide a method for controlling a telemanipulation robot which simplifies the set-up of a workcell of the robot.

The object is achieved according to the invention by the features of claim 1.

The method according to the invention is used to operate a robot, in particular a telemanipulation robot, and in particular to plan an operation using a robot. This may involve a medical operation, but also an industrial or another operation. A telemanipulation robot can comprise at least one manipulator arm, which is used to guide an instrument for manipulating an object. The object can be the body of a patient, for example, so that the telemanipulation robot is a telesurgery robot. The manipulator arm can be controlled by a user, such as a surgeon, by way of an input device.

According to the invention, the spatial position and/or location of at least one delimiting structure is detected, which causes a kinematic delimitation of the work space that can be reached by the instrument connected to the robotic arm of the robot. A delimiting structure shall be understood to mean any structure, which is to say any object in the operating range ,which can cause a kinematic delimitation of the work space that can be reached. Kinematic delimitation exists when the instrument of the manipulator arm cannot reach, or must not reach, a particular point in the operating area. Kinematic delimitations can thus be software or hardware delimitations.

For example, kinematic delimitation can be caused by a joint of the manipulator arm reaching the end stop thereof and not being able to move beyond this position. Software delimitation can be present when the manipulator arm must not be moved beyond a particular point since otherwise a risk structure would be harmed or damaged. A risk structure can be a sensitive vessel in a patient's body, for example. However, other risk structures that are to be protected can also be taken into consideration, for example in industrial applications. Kinematic delimitations of the work space can moreover result from other objects, for example due to the geometric design of the object to be manipulated in the workcell. When a telesurgery robot is used in minimally invasive surgery, kinematic delimitation can result from the trocar point through which the minimally invasive instruments are inserted into the patient's body. This point represents a kinematic delimitation of the work space insofar as it limits the number of available degrees of freedom for the movement of the manipulator arm.

According to the invention, the reachable work space is represented continuously in such a way that a change in the position or location of the delimiting structure results, in real time, in a change of the represented reachable work space. The representation of the reachable work space here takes place on an object that is to be manipulated by the instrument. In the case of surgical use, this may be a patient's body, for example. In the case of industrial use, this may be a different object that is to be manipulated.

In this way, the manipulator arm or the instrument can be positioned and oriented by the user on the object to be manipulated as part of the set-up of the workcell. During this positioning and orientation, the reachable work space is displayed to the user in real time by the method according to the invention. In this way, the user can very easily and quickly find out the position of the instrument that is required to reach a particular target work space, which must be accessible for a desired operation to be carried out by the instrument. Specifically, for example, a surgeon would position the instrument on a particular point of the patient's body in the case of a telesurgery robot, whereupon the reachable work space can be displayed directly to him on the patient's body. If this reachable work space does not correspond to the desired target work space, the surgeon can adjust the instrument until the desired result is reached. In this way, it is possible to configure the workcell particularly intuitively.

A representation of the reachable work space on the object to be manipulated shall be understood to mean that the work space to be reached is represented in a direct spatial relationship with the object that is to be manipulated. The work space can be represented by projection directly on the object itself that is to be manipulated, for example. In this embodiment, a projection thus takes place in the real world. For example, a projector, a laser pointer or the like can be used for this purpose. It is possible to directly project lines, spots or areas onto the object that is to be manipulated at the geometrically correct location. As an alternative or in addition, the reachable work space can be displayed together with the object to be manipulated as part of a virtual reality representation or an augmented reality representation. This can take place on a display, for example, on which the movements of the instruments of the telemanipulation robot are displayed to the user. The display also represents the object to be manipulated, so that the reachable work space can always be displayed on the display directly on the object that is to be manipulated.

The representation of the virtual reality can take place using lines, spots, areas, 3D objects or the like. In the case of a representation in the camera image by way of augmented reality, for example, the camera of a smart phone or a head-mounted display can be used.

The spatial position of the delimiting structure can be detected continuously, for example, and can take place in particular by moving the tip of the instrument to this position, and storing this position. Since the position of the tip of the instrument is always known to the control unit of the robotic arm due to the known joint angles of the robotic arm, the spatial position of the delimiting structure can be exactly detected by a movement to this position. This detection takes place directly in the coordinate system of the robotic arm. It is therefore known in the coordinate system of the robotic arm at which points kinematic delimitations of the work space exist. In addition, the control unit of the robotic arm of course knows the position of the robotic arm, and more particularly the spatial position of the base thereof. Based on this information, the reachable work space in the coordinate system of the robotic arm can be calculated and displayed. It is essential that the described information is present in a single coordinate system.

The described information can also be detected in different coordinate systems and then transformed into a shared coordinate system. For example, the spatial position of the delimiting structure can be detected by positioning the tip of a marking element at this position, and by detecting the spatial position of the tip of the marking element by way of a tracking system and storing this position. In this case, the position of the delimiting structure is known in the coordinate system of the tracking system. For a representation of the reachable work space in the coordinate system of the robotic arm, it would thus have to be converted into this coordinate system.

In addition to the position of the delimiting structure, the position of the robotic arm, and more particularly that of the base thereof, is used to calculate and display the reachable work space.

In addition to the reachable work space, a target work space can be displayed, which must be reached to carry out the planned manipulation on the object. The target work space depends on the planned operation. In particular the degree of overlap between the reachable work space and the target work space can then be displayed. This can be done in the form of a percentage, for example.

It is furthermore possible to display the distance between the manipulator arm and/or the instrument and the kinematic delimitation of the work space. In this way, it is particularly easy for a user to recognize the position into which the manipulator arm cannot be displaced and when this position is reached, Intuitive planning of the operation is thus additionally supported.

As a result of the described steps, it is in particular possible to dispense with time-consuming planning in virtual reality. Rather, it can be found out very quickly and easily to what degree the planned operation can be carried out with a particular configuration.

So as to more precisely calculate the reachable work space, it is preferred to measure the kinematic delimitations of the work space in the coordinate system of the manipulator arm. So as to display the target work space and the reachable work space at the same time, it is preferred to determine the target work space in the same coordinate system as the reachable work space. This can be the coordinate system of the manipulator arm.

It is furthermore preferred for the direction to be displayed in which the manipulator arm and/or the instrument must be moved to achieve greater overlap of the reachable work space with a desired target work space.

It can furthermore be displayed whether the base of the manipulator arm must be repositioned for improved reachability of a desired target work space.

It is furthermore possible that the manipulator arm, in the event of less than full overlap, is automatically moved in a direction that would result in greater overlap. This can be done by using a virtual spring, for example.

One preferred embodiment of the invention will be described hereafter based on one FIGURE.

The FIGURE shows a schematic illustration of a manipulator arm during an operation.

The manipulator arm 10 of a telesurgery robot is connected at the distal end thereof to an instrument 12, the tip of which is inserted into the body 14 of a patient via a puncture point 22. The reachable work space is denoted by reference numeral 16, while the desired work space bears the reference numeral 18. As can be seen in the FIGURE, these work areas 16, 18 are not congruent. Hence, overlap of 30% is displayed.

An arrow 24 can be displayed at the same time, which points in a direction in which the manipulator arm 10 would have to be moved to achieve greater overlap of the work areas 16, 18. Here, the trocar point would simultaneously be shifted. If necessary, the robotic arm 10 can be actively pressed in this direction. The reachable work space 16 can be displayed in the image of an imaging sensor, for example, such as of an endoscope, an ultrasound device, or the like.

In the described way, very fast, optimal positioning of the instrument 12 and of the robotic 10 relative to the object 14 to be manipulated can be achieved.

In addition to medical and industrial applications, the method according to the invention is also suitable for applications in the construction industry, for example for positioning cranes.

1-10. (canceled)

11. A method for operating a robot, comprising the following steps:
detecting the spatial position and/or location of at least one delimiting structure, which causes a kinematic delimitation of the work space that can be reached by an instrument connected to a robotic arm of the robot; and
continuously representing the reachable work space on an object to be manipulated by the instrument in such a way that a change in the position and/or location of the delimiting structure results, in real time, in a change of the represented reachable work space.

12. The method according to claim 11, wherein the spatial position of the delimiting structure is detected by moving the tip of the instrument to this position, and by detecting this position.

13. The method according to claim 11, wherein the spatial position of the delimiting structure is detected by positioning the tip of a marking element in this position, and by detecting the spatial position of the tip of the marking element by way of a tracking system.

14. A method according to claim 11, wherein, in addition to the position of the delimiting structure, the position of the robotic arm, and more particularly that of the base thereof, is used to calculate and display the reachable work space.

15. A method according to claim 11, wherein the work space is displayed by projection directly on the object to be manipulated itself, or on a display device together with the object to be manipulated as part of a virtual reality representation and/or an augmented reality representation.

16. A method according to claim 11, wherein, in addition to the reachable work space, a target work space is displayed, which must be reached to carry out the planned manipulation on the object, wherein in particular additionally the degree of overlap between the reachable work space and the target work space is displayed.

17. A method according to claim 11, wherein the distance between the manipulator arm and/or the instrument and a delimiting structure causing a kinematic delimitation of the work space is displayed.

18. A method according to claim 11, further comprising the step of:
measuring the kinematic delimitation of the work space in the coordinate system of the manipulator arm.

19. The method according to claim 18, wherein the robot is a telesurgery robot and the object to be manipulated is the body of a patient, and a puncture point for the instrument on the body of the patient is displayed as the kinematic delimitation of the work space.

20. A method according to claim 11, wherein additionally the direction is displayed in which the manipulator arm and/or the instrument must be moved to achieve greater overlap of the reachable work space with a desired target work space, wherein it is in particular additionally displayed whether the base of the manipulator arm must be repositioned for improved reachability of a desired target work space and/or, in the event of less than full overlap between the reachable work space and a desired target work space, the manipulator arm is automatically moved in a direction that results in greater overlap.
